(19) United States
(12) Patent Application Publication
(10) Pub. No.: US 2007/0033140 A1
(43) Pub. Date: Feb. 8, 2007

(54) Systems and methods for selecting hair dye products and method for marketing hair dye products

(76) Inventors: Patricia K. Slattery, Denville, NJ (US); Betsy Contant, New York, NY (US); Lisa Capparelli, New York, NY (US); Sasha Tulchin, New York, NY (US); Pia Hunter, New York, NY (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/495,757

(22) Filed: Jul. 31, 2006

Related U.S. Application Data
(60) Provisional application No. 60/703,873, filed on Aug. 1, 2005.

(51) Int. Cl. G06Q 99/00

(52) U.S. Cl. 705/50

(57) ABSTRACT

A system for facilitating selection of a hair dye product may include a front cover defining a plurality of windows and a plurality of representations of hair dye products associated with the plurality of windows. The system may further include at least one element including a plurality of representations of dyed hair colors. The front cover and the at least one element may be configured such that at least some of the representations of dyed hair colors may be viewed through at least some of the windows of the front cover, so that at least some of the representations of hair dye products may be associated with at least some corresponding representations of dyed hair colors.

### RELATED APPLICATION

This application claims the benefit of priority under 35 U.S.C. §119(e) of U.S. Provisional Application No. 60/703,873, filed on Aug. 1, 2005, the disclosure of which is incorporated herein by reference.

### BACKGROUND OF THE INVENTION

1. Field of the Invention

The present invention relates to systems and methods for selecting hair dye products and methods for marketing hair dye products. In particular, some aspects of the invention relate to systems and methods for selecting hair dye products based on an existing hair color and methods for marketing hair dye products using the systems and methods.

2. Description of the Related Art

Hair dye products may be use to alter existing hair colors in order to obtain a desired dyed hair color. It may often be challenging, however, to correctly anticipate the resulting dyed hair color and/or to select a hair dye product from a plurality of anticipated dyed hair color choices based on conventional dye product packaging and displays.

Some conventional dye product packaging, for example, may include a picture of an exemplary hair color that may be attained by using a particular hair dye product contained in the package. In some instances, such a picture alone may not provide an accurate indication of the actual hair dye color that would result by using the product. For example, there may be little or no indication on the packaging of the existing hair color prior to application of the hair dye product, even though a particular existing hair color is often needed in order to have some specific hair dying results. Consequently, it may be difficult for a consumer to accurately anticipate the dyed hair color that might be obtained by using a product.

Some conventional dye packaging may include both a picture of an existing hair color prior to application of the hair dye product and a picture of a dyed hair color following application of the hair dye product. Using such packaging alone to select a product may sometimes have drawbacks. For example, if a consumer is interested in learning all of the possible hair dying results that might be attained for a particular existing hair color, the consumer might need to consult multiple packages that are not necessarily arranged next to one another at a point of sale. Furthermore, since many hair dye products might not be suited for use with particular existing hair colors, a consumer may sometimes be forced to waste time sorting through products that are not of interest.

For these and other reasons, there is a need for alternative approaches that may overcome one or more of the above-outlined drawbacks with conventional systems.

One subject of the invention relates to providing a system for selecting a hair dye product based on an existing hair color. Another subject of the invention relates to providing a system for selecting a hair dye product in which a number of representations of dyed hair colors may be simultaneously viewed. Still a further subject of the invention relates to providing a system for selecting a hair dye product that provides choices for a number of existing hair colors along with a plurality of dyed hair colors for each of the plurality of existing hair colors. Yet another subject of the invention relates to providing a method for selecting a hair dye product based on a number of dyed hair color choices for an existing hair color. A further subject of the invention relates to providing a method for marketing hair dye products.

Although the present invention may obviate one or more of the above-mentioned drawbacks, it should be understood that some aspects of the invention might not necessarily obviate one or more of those drawbacks.

### SUMMARY

In the following description, certain aspects and embodiments of the present invention will become evident. It should be understood that the invention, in its broadest sense, could be practiced without having one or more features of these aspects and embodiments. In other words, these aspects and embodiments are merely exemplary.

One aspect of the invention relates to a system for facilitating selection of a hair dye product. The system may include a front cover defining a plurality of windows and a plurality of representations of hair dye products associated with the plurality of windows. The system may further include at least one element including a plurality of representations of dyed hair colors. The front cover and the at least one element may be configured such that at least some of the representations of dyed hair colors may be viewed through at least some of the windows of the front cover, so that at least some of the representations of hair dye products may be associated with at least some corresponding representations of dyed hair colors.

According to another aspect, a method of selecting a hair dye product may include providing a system for facilitating selection of a hair dye product. The method may further include selecting an element substantially corresponding to an existing hair color and positioning the element with respect to the front cover such that at least some of the representations of dyed hair colors of the element are visible through at least some of the windows of the front cover.

According to still a further aspect, a method of selecting a hair dye product may include selecting an element corresponding to an existing hair color. The element may include a plurality representations of dyed hair colors for the existing hair color. The method may further include selecting at least one of the plurality of representations of dyed hair colors and viewing the at least one selected representation through a window adjacent to a representation of a hair dye product.

According yet another aspect, a system for facilitating selection a hair dye product may include a plurality of elements. Each of the plurality of elements may include representations of dyed hair colors. The system may further include a front cover defining a plurality of windows and including representations of hair dye products adjacent to the windows. The plurality of elements and the front cover may be configured such that a plurality of the representations of dyed hair colors are simultaneously visible through at least some of the windows of the front cover.

In still a further aspect, a method of marketing hair dye products may include making a system for facilitating selection of a hair dye product available at a point of sale for the hair dye products.

Aside from the structural and procedural arrangements set forth above, the invention could include a number of other arrangements such as those explained hereinafter. It is to be understood that both the foregoing description and the following description are exemplary only.

### BRIEF DESCRIPTION OF THE DRAWINGS

The accompanying drawings are incorporated in and constitute a part of this specification. The drawings illustrate exemplary embodiments and, together with the description, serve to explain some principles of the invention. In the drawings,

FIG. 1 is a schematic view of an exemplary embodiment of a system for selecting a hair dye product;

FIG. 2 is a schematic view of an exemplary sleeve portion of the embodiment of FIG. 1;

FIG. 3 is a schematic view of an interior portion of the sleeve portion embodiment of FIG. 2;

FIG. 4 is a schematic view of an exemplary element of the embodiment of FIG. 1;

FIG. 5 is a schematic view of another exemplary element of the embodiment of FIG. 1;

FIG. 6 is a schematic view of a further exemplary element of the embodiment of FIG. 1;

FIG. 7 is a schematic view of another exemplary element of the embodiment of FIG. 1;

FIG. 8 is a schematic view of a further exemplary element of the embodiment of FIG. 1;

FIG. 9 is a schematic view of another exemplary element of the embodiment of FIG. 1;

FIG. 10 is a schematic view-of a further e exemplary element of the embodiment of FIG. 1;

FIG. 11 is a schematic view of another exemplary element of the embodiment of FIG. 1;

FIG. 12 is a schematic view of a further exemplary element of the embodiment of FIG. 1;

FIG. 13 is a schematic view of another exemplary element of the embodiment of FIG. 1; and

FIG. 14 is a schematic view of the embodiment of FIG. 1 with an element positioned such that representations of dyed hair color choices are visible.

### DESCRIPTION OF EXEMPLARY EMBODIMENTS

Reference will now be made in detail to exemplary embodiments of the invention. Wherever possible, the same reference numbers are used in the drawings and the description to refer to the same or like parts.

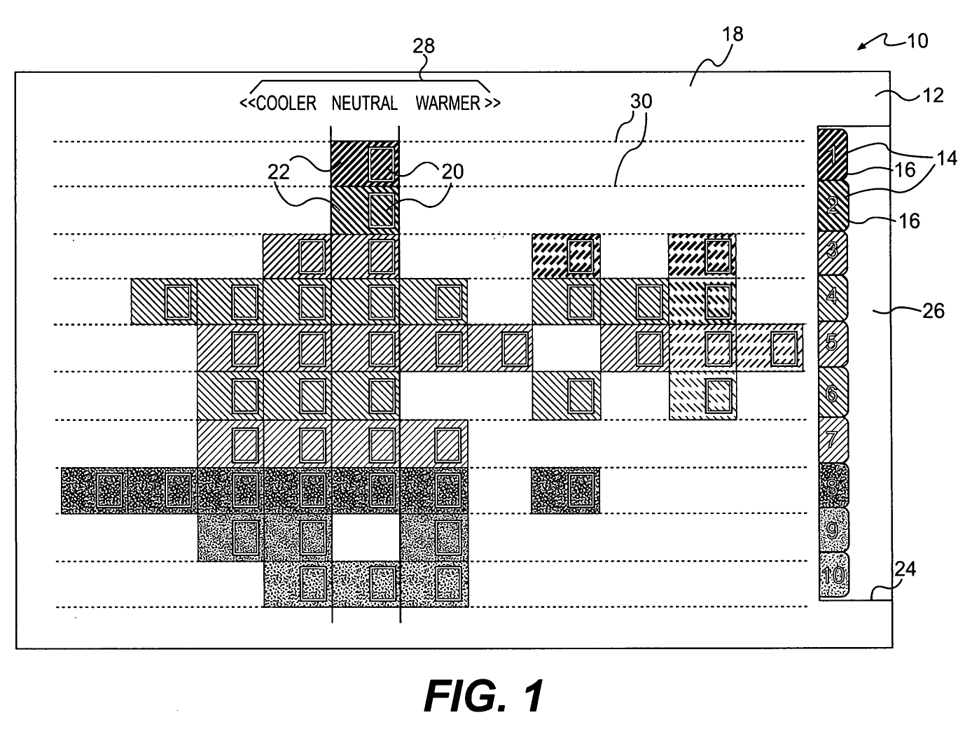

FIG. 1 depicts an exemplary embodiment of a system 10 for selecting a dye product. The system 10 may include a sleeve 12 configured to contain a number of elements 14. Each of the elements 14 may define a tab portion 16. The sleeve 12 and/or the elements 14 may be formed of, for example, paper products, laminated paper products, plastic products (e.g., thin plastic), and/or any other materials capable of performing as intended. For example, each of the elements 14 may be in the form of a card.

Each of the elements 14 may be configured to correspond to one or more existing hair colors. For example, the elements 14 designated 1-10 on tab portions 16, as shown in FIG. 1, may each represent an existing hair color shade ranging from, for example, dark brown (designated “1”) through light blond (designated “10”). Elements 14 that correspond to existing hair colors having red color shades may also be included.

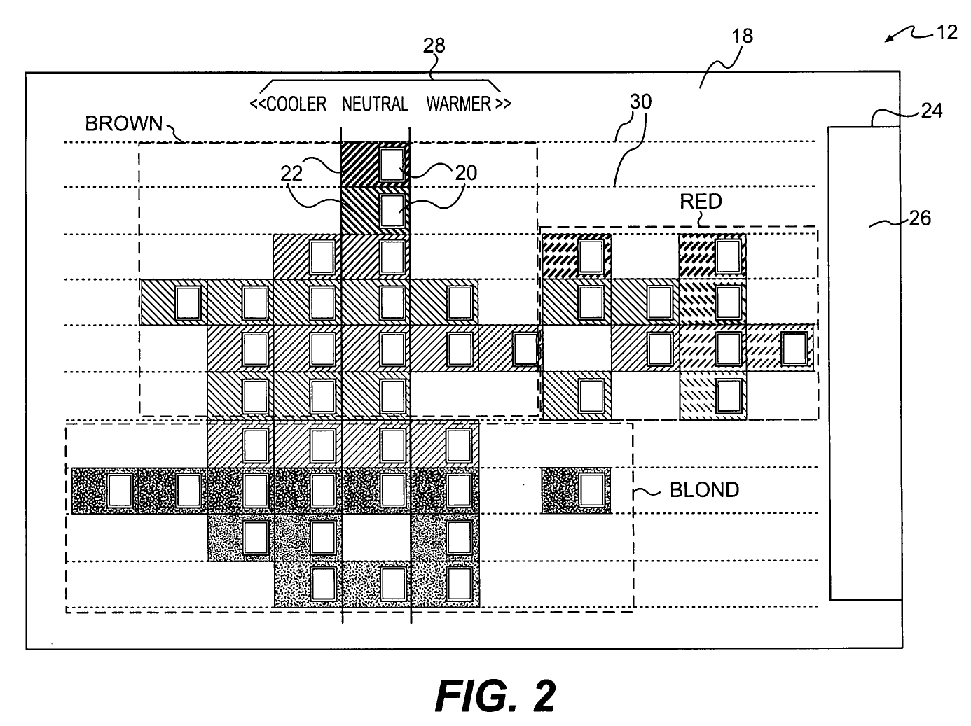

Referring to FIG. 2, the sleeve 12 may include a front cover 18 defining a plurality of windows 20 and a plurality of representations 22 of dye products. For example, the front cover 18 may be in the form a relatively opaque sheet having a plurality of apertures forming windows 20 and/or in the form a sheet having relatively translucent portions (e.g., relatively transparent portions) defining windows 20.

The representations 22 of dye products may be in various forms. For example, each of the representations 22 of hair dye products may be depictions of a hair dye color associated with a respective hair dye product and/or an alpha-numeric designation corresponding to a respective hair dye product. In some examples, each of the representations 22 may have a color corresponding to the particular color of a packaging that is used to contain a product (e.g., each of the product representations 22 may have a different color).

According to some exemplary embodiments, each of the representations 22 of dye products may correspond to one of the windows 20 defined by the front cover 18. For example, each representation 22 may be located adjacent to a respective window 20. The front cover 18 may also define a recess 24 configured to permit viewing of a portion (e.g., the tab portion 16) of one or more of the elements 14 along with a portion of an interior portion 26 of the sleeve 12.

According to some embodiments, the representations 22 of dye products and corresponding windows 20 may be arranged in groupings, for example, based on color shade. For example, in the exemplary embodiment depicted in FIG. 2, the representations 22 of dye products generally corresponding to differing shades of brown may be in a grouping, for example, such as the grouping labeled “BROWN” in FIG. 2. The representations 22 of dye products generally corresponding to differing shades of blond may be in a grouping, for example, such as the grouping labeled,“BLOND” in FIG. 2, and the representations 22 of dye products generally corresponding to differing shades of red may be in a grouping, for example, such as the grouping labeled “RED” in FIG. 2. The relative orientations of the groupings and/or labels depicted in FIG. 2 are merely exemplary, and other relative orientations and/or labels are contemplated.

The front cover 18 may also include a region 28 that characterizes an aspect of hair dye products. For example, the region 28 may provide an indication about the character of the dyed hair following treatment with an associated hair dye product. For example, the region 28 may provide an indication of the relative warmth or coolness of the dyed hair colors by providing labels such as, for example, “COOLER,” “NEUTRAL,” and/or “WARMER,” as depicted FIGS. 1 and 2, of the hair dye products represented on the front cover 18 based on the region of the front cover 18 on which the representations 22 are provided. For example, in the exemplary embodiment depicted in FIGS. 1 and 2, hair dye products corresponding to the hair dye product representations 22 located on the left side of the front cover 18 tend to contain cooler shades of color (e.g., shades including ashes, beiges, and/or tones that minimize red and/or orange tones), and hair dye products corresponding to the hair dye product representations 22 located on the right side of the front cover 18 tend to contain warmer shades of color (e.g., shades including gold tones). Hair dye products corresponding to the hair dye product representations 22 located between the representations 22 located on the left side and right side of the front cover 18 tend to contain neutral shades of color, for example, for maintaining the existing hair color. The characterizations (i.e., “COOLER,” “NEUTRAL,” and “WARMER” and/or the relative arrangements of those characterizations depicted in FIGS. 1 and 2 are merely exemplary and other characterizations and/or arrangements are contemplated.

According to some exemplary embodiments, the front cover 18 may include a number of lines 30 configured, for example, to assist with guiding a user's attention across the front cover 18 in alignment with each of tab portions 16 of the elements 14.

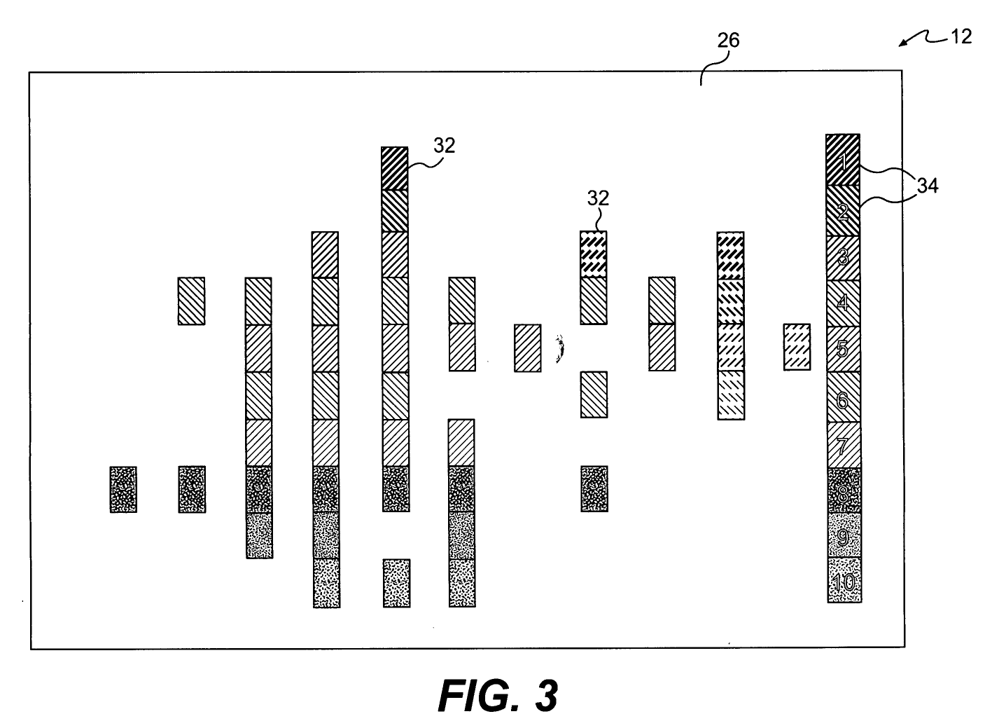

Referring to FIG. 3, the interior portion 26 of the sleeve 12 may include a back surface including a plurality of regions 32 that represent colors that may be associated with the representations 22 of hair dye products. The regions 32 may substantially match, for example, the representations 22 of the hair dye products located on the front cover 18, and the regions 32 may be located so that they are visible through at least some of the windows 20 of the front cover 18 when none of the elements 14 is positioned such that visibility of the back surface of the interior portion 26 is obstructed.

According to some exemplary embodiments, the back surface of the interior 26 of the sleeve 12 may include representations 34 each corresponding to one of the elements 14 that may be received within the sleeve 12. For example, the representations 34 may include regions that are identified by an alpha-numeric identifier (e.g., 1, 2, 3, etc.) and/or a color corresponding to the elements 14.

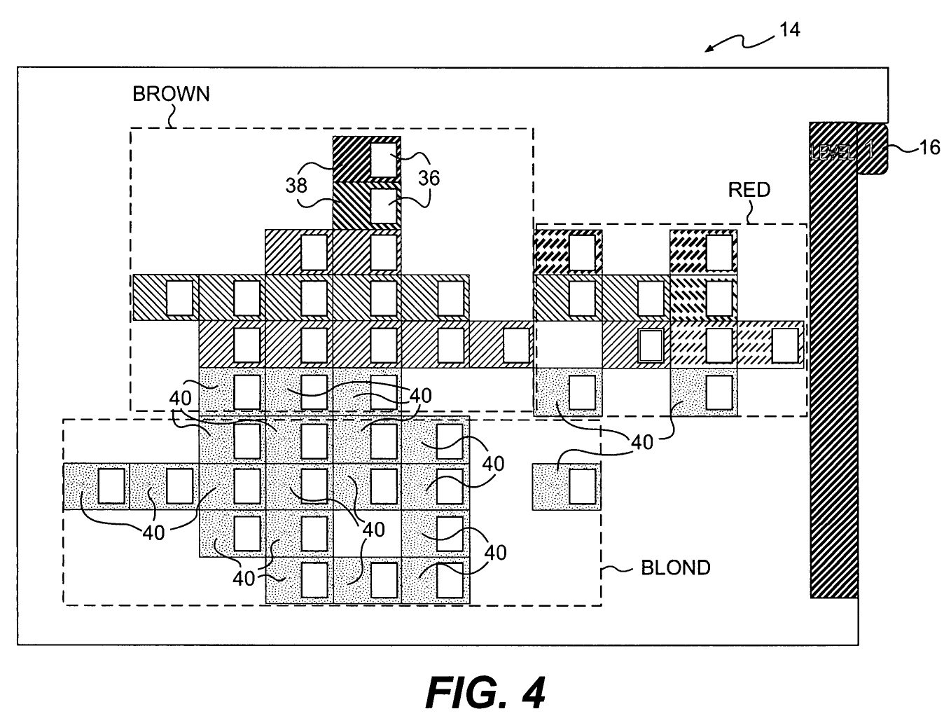

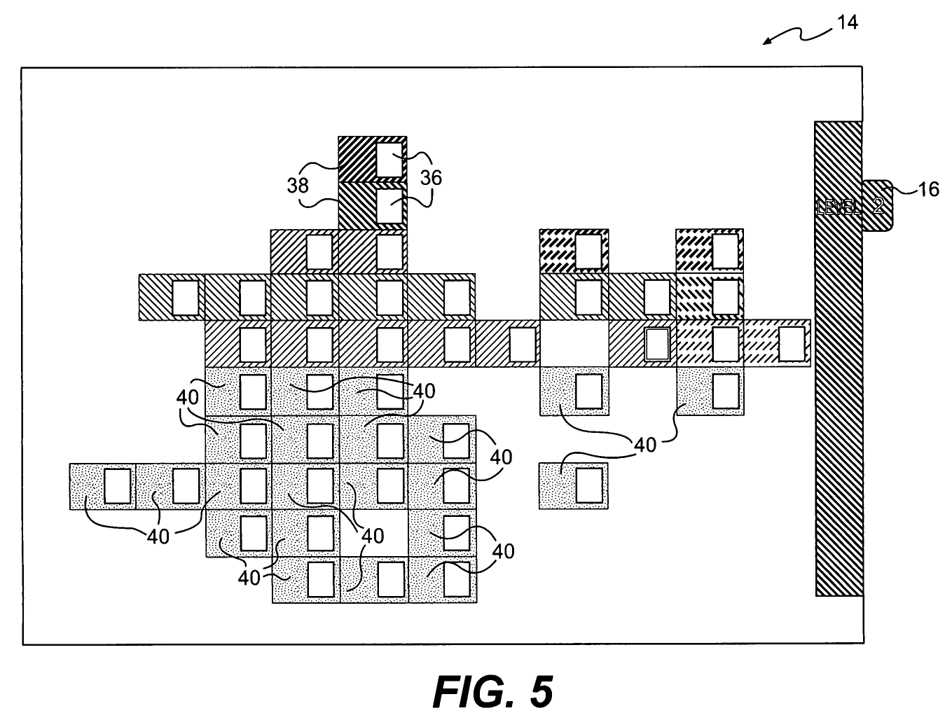

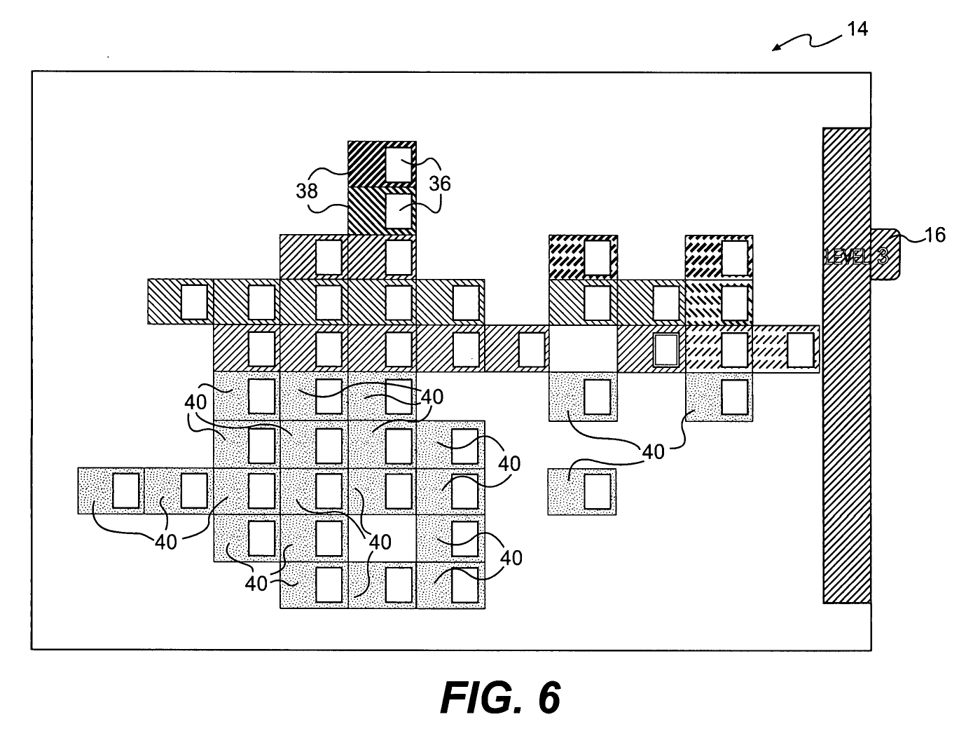

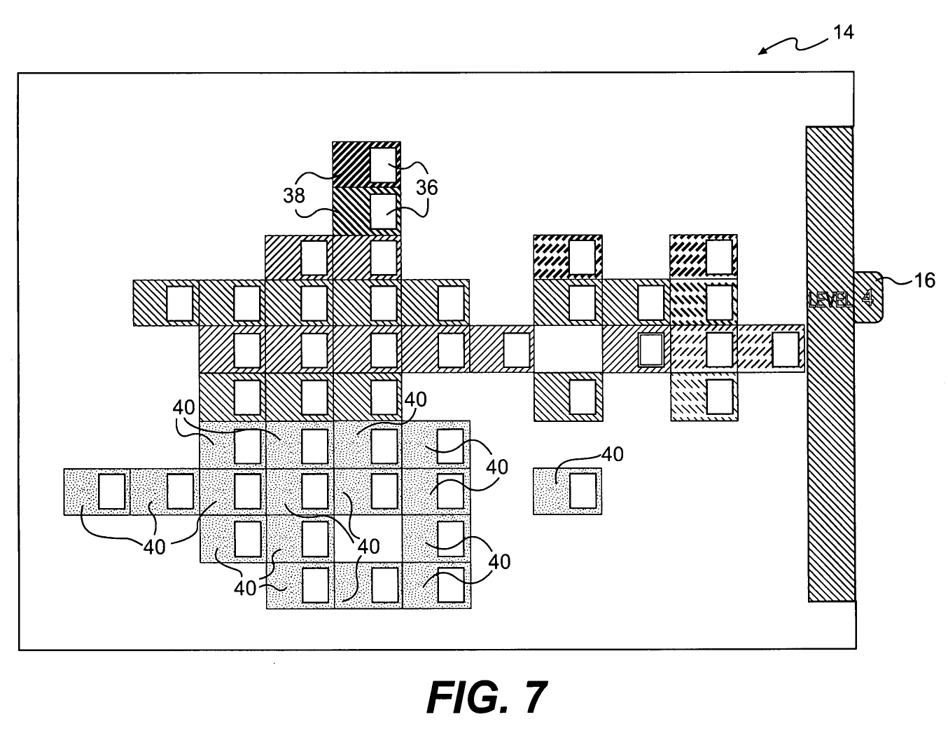

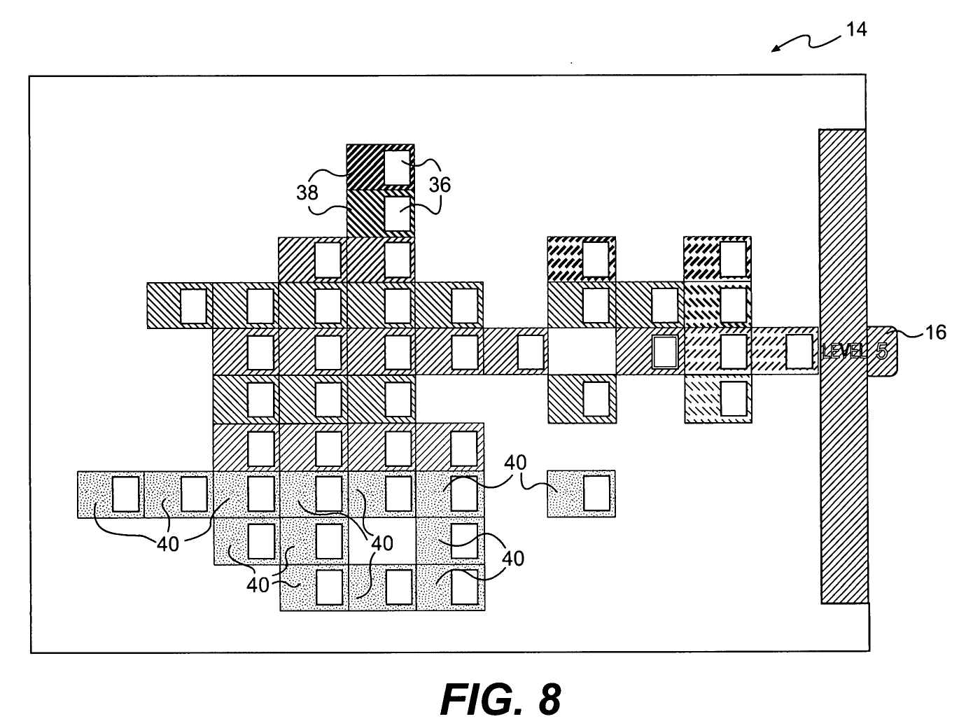

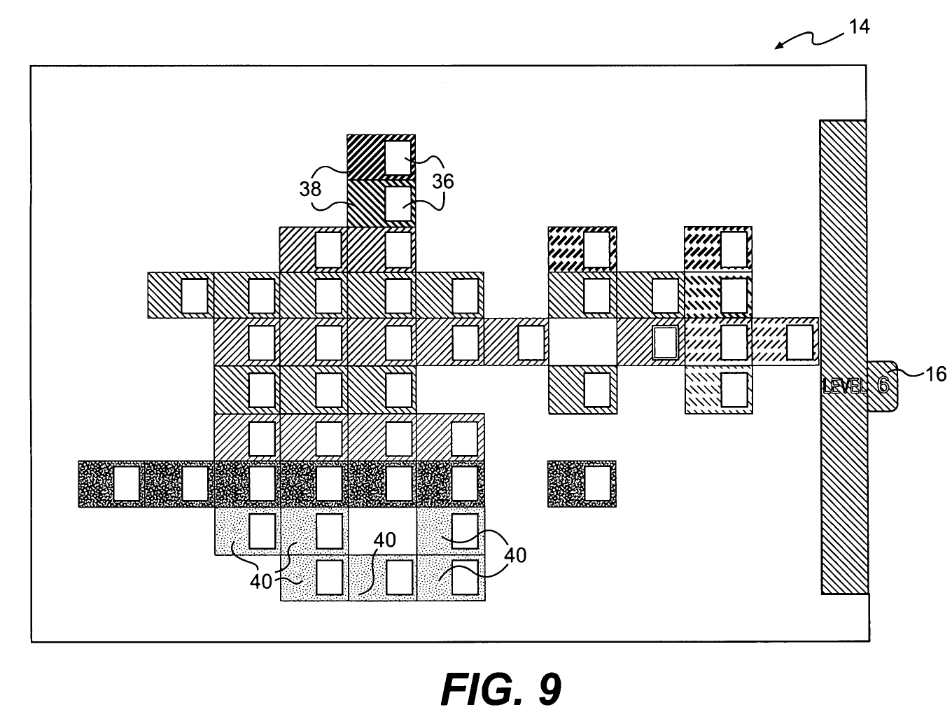

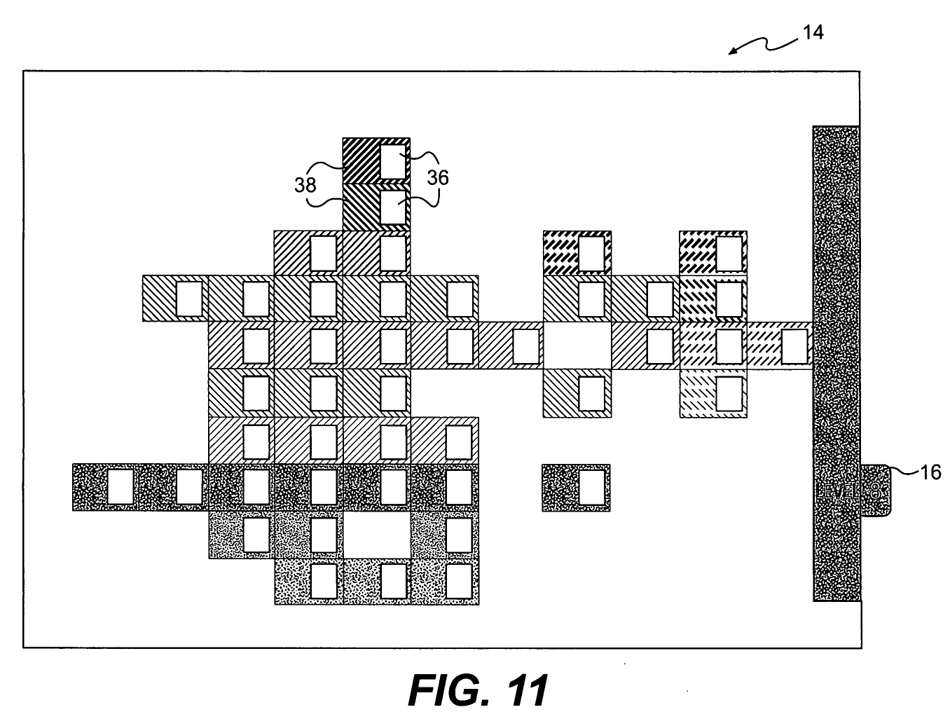

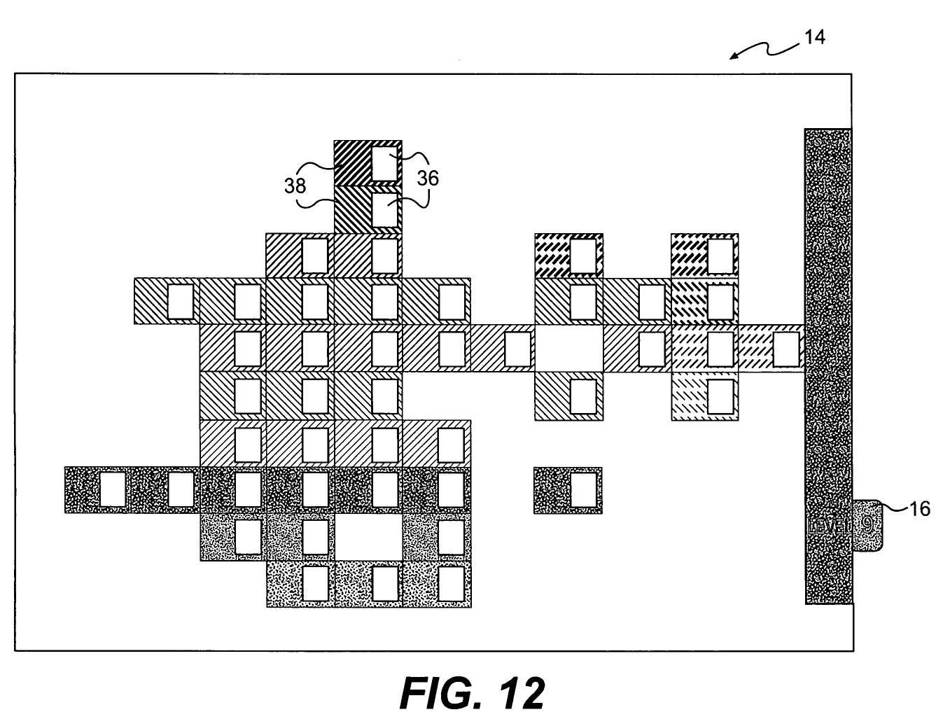

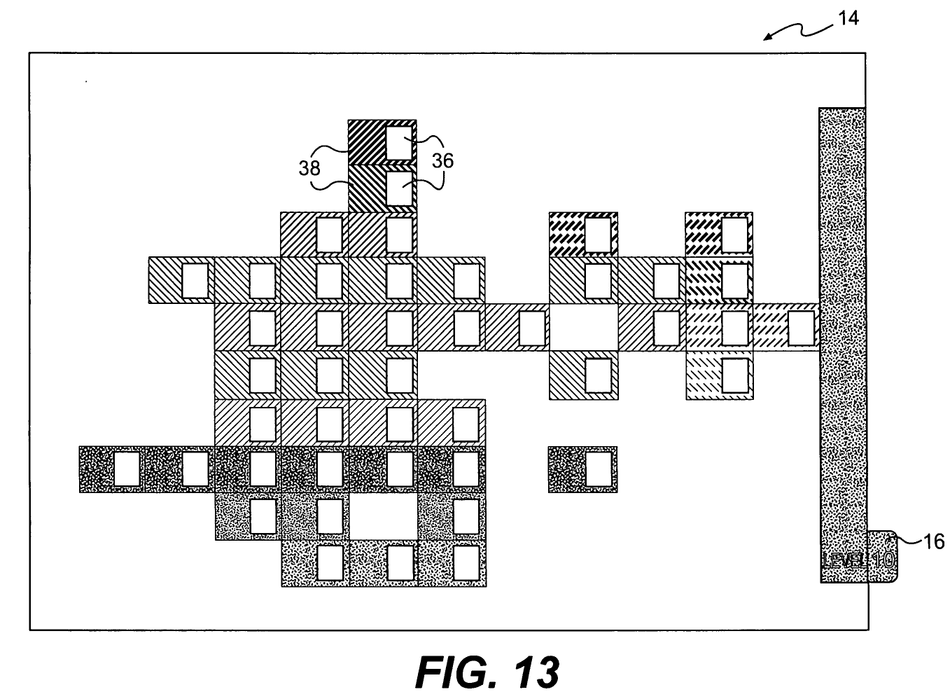

Each of the elements 14 may correspond, for example, to an existing hair color. For example, FIGS. 4-13 schematically depict a plurality of exemplary elements 14, each corresponding to a different existing hair color, so that the plurality of the elements 14 may correspond to a number of possible existing hair colors. As depicted in FIG. 4, for example, the element 14 may include a tab portion 16, which may provide a representation of an existing hair color. The representation of the tabbed portion 16 may be in the form of, for example, an alpha-numeric identifier (e.g., 1, 2, 3, etc.), a depiction selected to simulate an existing hair color, and/or a swatch of hair (or simulated hair) approximating an existing hair color.

The elements 14 may include a plurality of windows 36 and a plurality of representations 38 of dyed hair colors. Each of the representations may be located adjacent to a respective window 36. The windows 36 may be in the form of apertures and/or generally translucent regions (e.g., generally transparent regions). For example, the windows 20 may be in the form of apertures in a relatively opaque sheet and/or the windows may be in the form of relatively translucent sheet portions (e.g., a relatively transparent sheet portions).

The representations 38 of dyed hair colors may be representations of anticipated hair colors that would result by using particular hair dye products (e.g., the hair dye products represented by representations 22 on the front cover 18) to dye hair having an existing hair color corresponding to the particular element 14. The representations 38 may be in various forms. For example, the representations 38 could be pictures, colored portions, colored laminated paper, colored thin plastic, and/or one or more swatches colored hair (or simulated colored hair).

The element 14 depicted in FIG. 4 may be received in the sleeve 12 and may be positioned within the sleeve 12 such that one or more of the representations 38 of dyed hair colors is visible through one or more of the windows 20 of the front cover 18 of the sleeve 12. When visible through the windows 20, at least some of the representations 38 of dyed hair colors may be associated with at least some of the representations 22 of hair dye products corresponding to the windows 20. In this manner, a hair dye product may be selected by, for example, reviewing the representations 38 visible in the windows 20, identifying a visible representation 38 that is closest to a desired dyed hair color, and selecting a hair dye product that is represented by the product representation 22 adjacent to the window 20 in which the identified representation 38 is visible.

According to some embodiments, the representations 38 of dyed hair colors and corresponding windows 20 may be arranged in groupings, for example, based on color shade, that correspond to groupings of hair dye product representations 22 on the front cover 18. For example, in the exemplary embodiment depicted in FIG. 4, the representations 38 of dyed hair colors generally corresponding to differing shades of brown may be in a grouping, for example, such as the grouping labeled “BROWN” in FIG. 4. The representations 38 of dyed hair colors generally corresponding to differing shades of blond may be in a grouping, for example, such as the grouping labeled “BLOND” in FIG. 4, and the representations 38 of dyed hair colors generally corresponding to differing shades of red may be in a grouping, for example, such as the grouping labeled “RED” in FIG. 4. The relative orientations and/or labels depicted in FIG. 4 are merely exemplary, and other relative orientations and/or labels are contemplated.

According to some exemplary embodiments, the elements 14 may include regions that include an indication suggesting that no dye product is recommended for a particular existing hair color. For example, as depicted in FIGS. 4-9, regions 40 include an indication suggesting that there is no representation 38 of dyed hair color corresponding to the dye product representations 22 located on the corresponding portion of the front cover 18.

For example, the element 14 depicted in FIG. 4 may correspond to an existing hair color of dark brown. In FIG. 4, the regions 40 of element 14 may correspond to dye products in the blond hair color range. Since dye products in the blond hair color range may often render unsatisfactory results when applied to hair having an existing dark brown color, the regions 40 may include an indication suggesting that there is no representation 38 of dyed hair color corresponding to the blond hair color dye product representations 22 located on the corresponding portion of the front cover 18. In such cases, the regions 40 may be visible through the windows 20 located on the front cover 18 rather than representations 38 of dyed hair color choices, where no dye product is recommended for achieving a particular shade of color based on an incompatible existing hair color. The region 40 may include be an alpha-numeric indication, such as, for example, “not available,” and/or a color that would suggest a lack of recommended use, such as, for example, gray color.

During use of the exemplary system 10, a user of the system 10 may select a hair dye product based on the user's existing hair color and a plurality of dyed hair colors. For example, each of the elements 14 may correspond to a particular existing hair color and may include a plurality of representations 38 of dyed hair colors for the particular existing hair color. The representations 38 of dyed hair colors may, in turn, correspond to representations 22 of hair dye products on the front cover 18 of the sleeve 12.

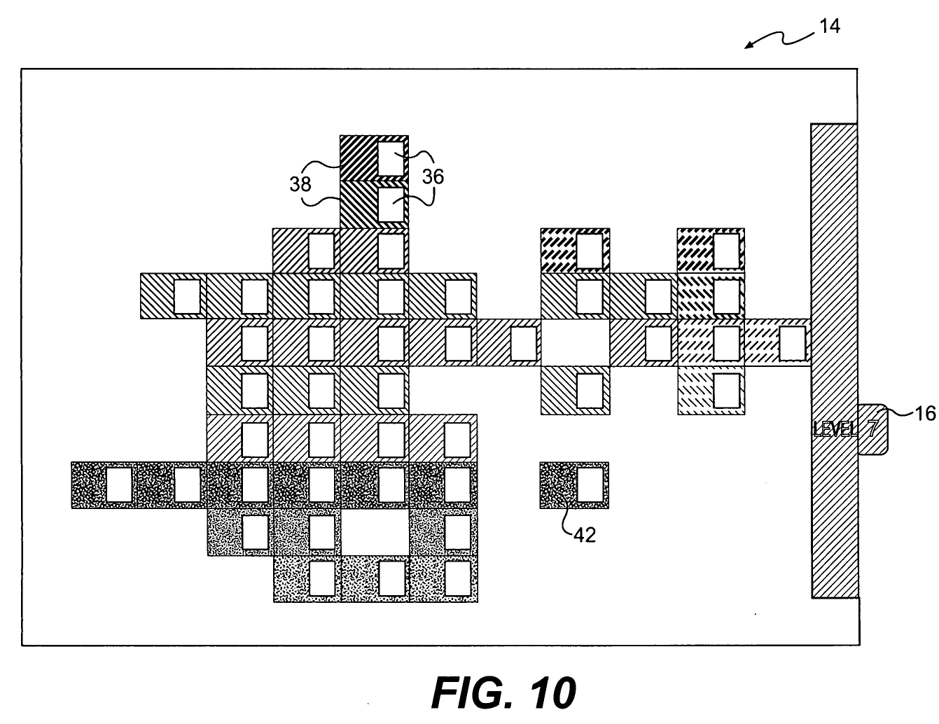

Referring to FIG. 10, a system 10 for selecting a hair dye product may include a sleeve 12 and a plurality of elements 14 that each correspond to existing hair color. The elements may be stacked on top of one another and received in the sleeve 12, such that the windows 38 of the elements 14 are in substantial registration with one another. According to some exemplary embodiments, by virtue of the windows 38 of the elements 14 being in substantial registration, the regions 32 located on the back surface of the interior portion 26 of the sleeve 12 may be visible through at least some of the windows 20 defined by the front cover 18 of the sleeve 12.

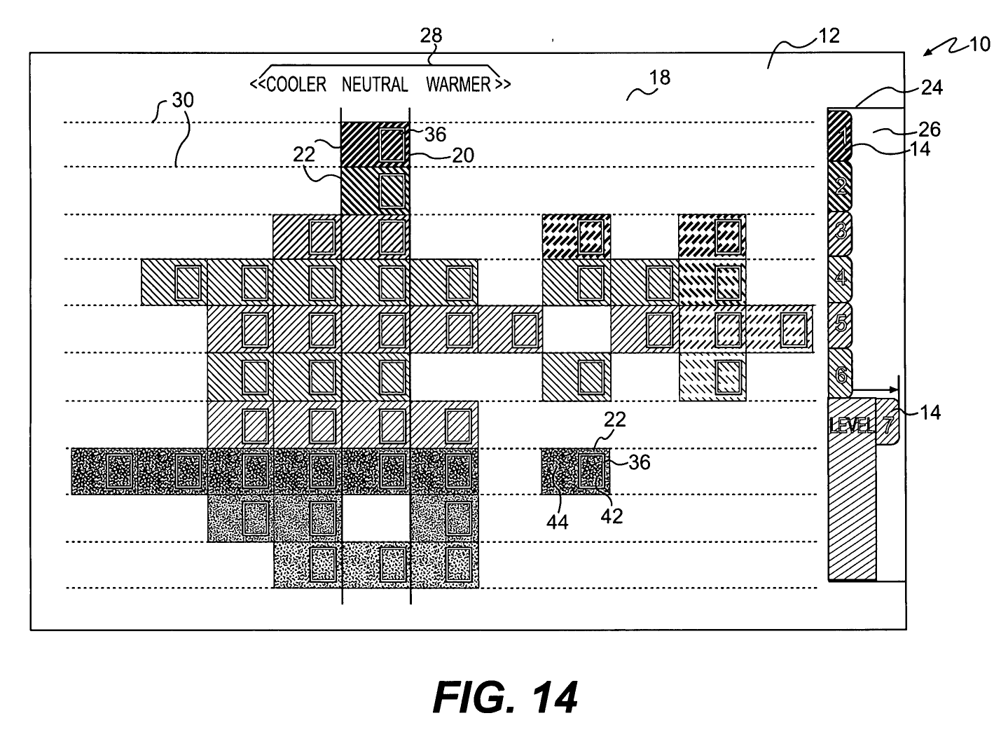

A user may select an element 14 that most closely approximates the user's existing hair color. In the exemplary arrangement shown in FIG. 14, one of the elements 16 may be selected by choosing the representation on tabbed portion 16 that most closely approximates the user's existing hair color. For example, if a user's existing hair color is most closely approximated by the exemplary element 14 depicted in FIG. 10, a user may select that element. The user may then slide the selected element 14 within the sleeve (e.g., to the right as shown in FIG. 14) such that the tab portion 16 extends beyond the tab portions 16 of the other element 14 that were not selected. By sliding the selected element as shown in FIG. 14, the representations 38 of dyed hair colors included on that element become visible though the windows 20 of the front cover 18 and the windows 36 in the elements 14 that are placed in the sleeve 12 on top of the selected element. As a result, a plurality (e.g., all) of the representations 38 of dyed hair color choices depicted on the element 14 corresponding to the user's existing hair color may be viewed by the user simultaneously. The user may then select one of the visible representations 38, for example, dyed hair color representation 42, (see FIGS. 10 and 14) and identify a product representation 22, for example, representation 44, (see FIG. 14) that corresponds to the selected representation. The representation 44 of hair dye product corresponds to a hair dye product that may be used to result in a dyed hair color that generally approximates the dyed hair color representation 42 selected by the user.

According to some embodiments, the elements 14 may not necessarily include windows 36. For example, although the exemplary embodiment of system 10 depicted in FIGS. 1-14 may include a sleeve 12 and a plurality of elements 14 received in the sleeve 12, the front cover 18 may be in the form of an element (e.g., a card) (not shown) rather than a portion of a sleeve. For example, rather than the elements 14 being placed in a sleeve, the elements 14 may be independent from one another, for example, such that a user may select an element 14 (e.g., from a collection of elements 14) generally corresponding to the user's existing hair color and position the selected element 14 underneath the front cover 18. The user may thereafter select a dye product corresponding to a selected representation 38 of dyed hair color choice indicated on the selected element 14.

According to some embodiments, the front cover 18 and a plurality of elements 14 may be held to one another such that the elements 14 may be rotated with respect to the front cover 18. For example, one or more of the cards 14 may be attached in a rotatable fashion to the front cover 18, for example, along one edge or at a corner thereof. The user may select a card 14 corresponding to the user's existing hair color and rotate the selected element 14 so that the element 14's representations 38 of dyed hair color choices are visible through the windows 20 of the front cover 18. The user may then select a representation 38 of dyed hair color choice and a corresponding representation 22 of hair dye product. According to such embodiments, the elements 14 may not necessarily define windows.

According to some embodiments, a method of marketing hair dye products may include providing a system 10 for selecting a hair dye product at a point of sale where hair dye products are sold (e.g., at a retail location). For example, a system 10 may be configured to provide representations of all of the hair dye products associated with an entire line and/or brand of hair dye products for a full range of existing hair colors. For example, a system 10 may be configured to provide representations of at least substantially all hair dye products marketed under a common product name. A consumer may use the system 10 to select a hair dye product, for example, either with the assistance of sales personnel or alone, for example, using instructions for using the system 10 that may be provided along with the system 10.

It will be apparent to those skilled in the art that various modifications and variations can be made to the structures and methods described herein. Thus, it should be understood that the invention is not limited to the subject matter discussed in the specification. Rather, the present invention is intended to cover modifications and variations.

What is claimed is:

1. A system for facilitating selection of a hair dye product, the system comprising:
a front cover defining a plurality of windows and a plurality of representations of hair dye products associated with the plurality of windows; and
at least one element comprising a plurality of representations of dyed hair colors,
wherein the front cover and the at least one element are configured such that at least some of the representations of dyed hair colors may be viewed through at least some of the windows of the front cover so that at least some of the representations of hair dye products may be associated with at least some corresponding representations of dyed hair colors.

2. The system of claim 1, wherein the representation of hair dye products comprise representations of at least substantially all hair dye products marketed under a common product name.

3. The system of claim 1, wherein the representations of dyed hair colors comprise representations of dyed hair colors attainable through use of at least some of the hair dye products.

4. The system of claim 1, wherein the at least one element defines a plurality of windows configured to substantially register with at least some of the plurality of windows of the front cover.

5. The system of claim 1, wherein the system comprises a plurality of elements each configured to correspond to at least one existing hair color and comprising a plurality of representations of dyed hair colors corresponding to the at least one existing hair color.

6. The system of claim 5, wherein at least some of the plurality of elements defines a plurality of windows configured to substantially register with at least some of the plurality of windows of the front cover.

7. The system of claim 6, wherein the plurality of elements are configured to be placed in an at least partially overlapping relationship with respect to one another such that at least some of the windows of at least one of the elements are in substantial registration with at least some of the windows of at least another of the elements.

8. The system of claim 7, wherein the front cover and the plurality of elements are configured such that at least some of the representations of dyed hair colors of one of the plurality of elements are visible through at least some of the windows of the front cover.

9. The system of claim 1, further comprising a sleeve comprising the front cover, wherein the sleeve and the at least one element are configured such that the at least one element is slidably received within the sleeve.

10. The system of claim 9, wherein the at least one element comprises a plurality of elements, and the front cover and the plurality of elements are configured such that at least some of the representations of dyed hair colors of one of the plurality of elements are visible through at least some of the windows of the front cover.

11. The system of claim 10, wherein each of the plurality of elements comprises at least one respective representation of an existing hair color, and the sleeve and the plurality of elements are configured such that representations of existing hair colors are visible when the plurality of elements are located within the sleeve.

12. The system of claim 11, wherein the representations of existing hair color comprise tabs, the tabs being visible along one edge of the sleeve.

13. The system of claim 12, wherein at least some of the representations of existing hair colors comprise a colored area.

14. The system of claim 12, wherein at least some of the representations of existing hair color comprise an alpha-numeric identifier.

15. The system of claim 12, wherein the sleeve and the plurality of elements are configured such that at least one of the plurality of elements is selectively movable with respect to another of the plurality of elements such that at least some of the representations of dyed hair colors of one of the elements are visible through at least some of the windows of the front cover and at least some of the windows of the elements.

16. The system of claim 1, wherein each of the representations of hair dye products is located adjacent an associated window of the front cover.

17. The system of claim 1, wherein each of the representations of hair dye products comprises a colored area.

18. The system of claim 1, wherein each of the representations of hair dye product comprises an alpha-numeric identifier.

19. The system of claim 4, wherein at least some of the windows of the at least one element are positioned such that when a plurality of the elements are positioned in at least partially overlapping relation, the windows of at least some of the elements are in substantial registration with the windows of at least one of the elements.

20. The system of claim 19, wherein the representations of dyed hair colors are positioned on the elements such that when one of the elements is moved in relation to the other elements, at least some of the representations of dyed hair colors of the one element are visible through at least some of the windows of the front cover.

21. The system of claim 20, wherein the representations of dyed hair colors of the one element are visible through at least some of the windows of at least one other element and at least some of the windows of the front cover.

22. The system of claim 4, further comprising a sleeve comprising the front cover, wherein the at least one element comprises a plurality of elements, the plurality of elements being configured to be received in the sleeve and being positionable such that at least some of the windows of the sleeve and at least some of the windows of the elements may be placed in substantial registration with one another.

23. A method of selecting a hair dye product, the method comprising:
providing the system of claim 1;
selecting an element substantially corresponding to an existing hair color; and
positioning the element with respect to the front cover such that at least some of the representations of dyed hair colors of the element are visible through at least some of the windows of the front cover.

24. The method of claim 23, further comprising selecting a dyed hair color from among the plurality of representations of dyed hair colors; and purchasing a hair dye product corresponding to the selected dyed hair color.

25. A method of selecting a hair dye product, the method comprising:
selecting an element corresponding to an existing hair color, the element comprising a plurality representations of dyed hair colors for the existing hair color;
selecting at least one of the plurality of representations of dyed hair colors; and
viewing the at least one selected representation through a window adjacent to a representation of a hair dye product.

26. A system for facilitating selection a hair dye product, the system comprising:
a plurality of elements, each of the plurality of elements comprising representations of dyed hair colors;
a front cover defining a plurality of windows and comprising representations of hair dye products adjacent to the windows,
wherein the plurality of elements and the front cover are configured such that a plurality of the representations of dyed hair colors are simultaneously visible through at least some of the windows of the front cover.

27. A method of marketing hair dye products comprising:
making the system of claim 1 available at a point of sale for the hair dye products.
